(19) United States
(12) Patent Application Publication
(10) Pub. No.: US 2016/0019646 A1
(43) Pub. Date: Jan. 21, 2016

(54) COMPUTER SYSTEMS AND METHODS FOR BALANCING INDEXES

(71) Applicant: THE NASDAQ OMX GROUP, INC., New York, NY (US)

(72) Inventors: Dave GEDEON, Rockville, MD (US); Darrin DECOSTA, Naperville, IL (US); Matthew PATTERSON, Naperville, IL (US)

(21) Appl. No.: 14/336,339

(22) Filed: Jul. 21, 2014

(51) Int. Cl. G06Q 40/06

(52) U.S. Cl. CPC G06Q 40/06; G06Q 40/04

(57) ABSTRACT

An index rebalancing computer system is provided that automatically rebalances an index and the component weights of one or more securities in the index. The system tracks and stores a value that represents an amount of cash generated by securities in the index over a predetermined time period. The index is rebalanced by at least adjusting a weight or a value of a second security included in the group of securities based on the value that indicates the amount of cash generated by securities in the index. An updated index value is calculated for the index based on the group of securities that includes the second security with the adjusted weight. Index component data is transmitted to subscribing entities.

### TECHNICAL OVERVIEW

The technology herein relates to computing systems that balance or rebalance indexes and the components that makeup the index.

### INTRODUCTION

Computerized financial systems provide important contributions in today's society by allowing entities (e.g., companies, organizations, individuals) to invest, obtain capital, offset risk (or take on new risk), etc. in a timely, efficient, and secure manner. An example computerized financial system is an electronic exchange platform (e.g., the NASDAQ® Stock Exchange) used to electronically buy and sell stock or other types of securities. Different entities can place electronic orders to trade through such a computerized exchange.

One technique in which the performance of a market (e.g., a given collection of securities) may be tracked is by electronically computing an index based on that market. This type of computerized index provides a representation of how the securities which makeup the index are performing and can help assist in determining the performance of an individual security against the performance of the market.

The NASDAQ-100 Index is an example index that includes 100 of the largest domestic and international non-financial securities listed on the NASDAQ® Stock Exchange. This index reflects how a collection of particular industries (e.g., computer hardware and software, telecommunications, retail/wholesale trade, and biotechnology) are performing. Other types of indexes may include bond indexes that measure a section of the bond market (e.g., corporate, municipal, and/or government backed bonds) or specific sector indexes that track, for example, companies in the information technology sector.

While indexes are easily understandable by ordinary investors (e.g., by assigning a single number to a collection of stocks), one downside is that they cannot be directly invested in. In other words, if the value of an index is 4000, an investor cannot buy a share in the index for 4000. However, investors can invest in an “index-fund” that tracks the index. These funds include managed mutual funds, unit investment trusts, exchange-traded funds (ETFs), and other types of funds that “own” assets of a given collection of securities (e.g., stocks, bonds, etc). The makeup of a particular fund (e.g., what assets are owned by a fund) can then be based on an index and achieve returns that are inline with an underlying index (such as the NASDAQ-100 Index).

One problem faced by indexes is the need to rebalance in order to address changes in the market such as the addition or deletion of components from an index, adjustment of index component weightings, etc. For traditional indexes, this rebalancing involves a two-step process that is typically implemented on computerized system. The process includes: (1) identification of eligible index components based on a given criteria—e.g., a market capitalization threshold, investment rating, economic sector, etc; and (2) calculation of how eligible index components are weighted within the index according to some technical criteria (for example pro-rate share based on market valuation or some other metric).

Rebalancing an index in this manner generates or regenerates a portfolio of index components that reflects the technical rules that govern the makeup of the index (e.g., which securities are eligible and how they are to be weighted). However, this technical precision may result in increased levels of turnover within the index.

As discussed above, investors do not directly “buy” a particular index. Rather, they buy a fund created to track the index. When an index is rebalanced by adjusting the makeup of the index (e.g., a security is dropped, added, or adjusted in weight), the fund tracking the index is typically similarly adjusted by a fund manager. At each rebalancing, as new securities become eligible for the index, each incumbent security may have its own weight reduced pro-rata in the index (e.g., an index addition security weight reduction). Similarly, as incumbent securities become ineligible, each remaining incumbent security can have its own weight increased pro-rata in the index (e.g., an index deletion security weight increase). A fund tracking such an adjusted index would need to adjust its holdings of a particular security or a group of securities in order to match the weightings used by the index.

While such rebalancing does not create costs for the index and thus negatively affect index performance, the corresponding rebalancing needed by a fund tracking the index can be expensive because rebalancing the fund—e.g., buying and selling securities by the fund (the turnover)—typically results in increased costs that can include broker fees, exchange fees, manager fees, bid/offer spread, and the like. These increased costs lower the overall return provided to investors in the fund. Over time, rebalancing can cause high turnover levels, which can lead to relatively high trading costs for the fund. This negatively impacts the performance of funds that seek to track a given index. Thus, while there is little or no trading cost associated with rebalancing an index for the index provider, there can be significant rebalancing costs incurred by funds seeking to deliver the performance of the index.

### SUMMARY

An index rebalancing computer system for a group of securities represented by an index includes a transceiver, a memory device, and a processing system that includes at least one processing circuit coupled to the memory and the transceiver. The transceiver is configured to send and receive electronic communication signals from or to one or more remote computers. The memory device is configured to store a listing of a group of securities used to generate the index and an indication of an amount of cash generated by at least a first security from among the group of securities over a certain time period. The processing system, in response to an index rebalance request signal, is configured to rebalance the index towards a target index by at least adjusting a weight of a second security associated with in the group of securities as a function of the stored indication of the amount of cash generated by at least the first security over the certain time period. The processing system calculates an index value for the index based on the group of securities that includes the second security with the adjusted weight and transmits transmit index component data, via the transceiver, to the one or more remote computers in accordance with the rebalanced index.

By implementing such a computerized process to rebalance an index, funds that track the index may have decreased turnover compared to other funds that track traditionally rebalanced indexes. This decreased turnover can result in less costs and better realized performance vis a vis the index (perhaps significantly so) for the fund.

In certain example embodiments, a computer indexing system stores and tracks a portfolio of securities and cash flows generated by those securities during a given time period (e.g., a month). In some examples, values that represent the generated cash flows are received from an external or remote data provider on a time-based (e.g., monthly) or event-based trigger (e.g., a manual request for the data). In certain examples, the generated cash flows tracked by the system are used to adjust the weightings of securities within an index maintained by the computer indexing system. In other words, the amount that a security may be adjusted in weight may be dependent or in proportional to the cash flow generated by the component securities within the index.

In certain example embodiments, a rebalancing process uses index cash flows generated by index components since the last index rebalancing to facilitate the rebalance process. The index rebalancing process may produce a target portfolio that guides the application of index cash balances to create a turnover optimized index (e.g., an index that decreases the turnover of index components versus prior techniques). The index process may include: (1) identifying of eligible index components through the application of a securities of screens; (2) weighting eligible index components according to a predetermined methodology to create a target portfolio; and (3) applying cash balances of the index to eligible index components proportionately to the extent they are underweighted relative to the target portfolio.

In certain examples, index turnover is decreased by eliminating needless index turnover through elimination of index adjustments which result from index addition security weight reductions or index deletion security weight increases. In certain examples, the rebalancing process is able to achieve decreased turnover while delivering index risk and return characteristics that track (and may be substantially identical to) traditionally rebalanced indexes. In other words, while the risk and return on a fund that tracks an index may be similar to that of a traditionally rebalanced index, the turnover associated with managing the fund's performance may be decreased due to the way in which the index provider has rebalanced the index. This results in increased returns for investors.

In certain examples, and on a monthly basis, each index seeks to divest cash equivalents that have been generated by index constituents and incorporate any new bonds that qualify for inclusion in such index to create a pro forma index. In certain examples, a rebalancing process may include a sale constraint on the portfolio that effectively bars the selling of securities (e.g., subtracting the value of securities from the index) from the portfolio as long as the securities remain valid securities.

The features described herein may be combined to form additional embodiments and sub-elements of certain embodiments may form yet further embodiments.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 illustrates a non-limiting example function block diagram of a computer-implemented index system coupled via a network to data source computer systems and subscriber or client computing systems;

FIG. 2A is a flow chart of an example computerized rebalancing process according to certain example embodiments;

FIG. 2B is a flow chart showing a computerized process for maintaining, publishing, and updating an index;

FIG. 3 is a chart showing allocations of a laddered index according to certain example embodiments;

FIG. 4 is a chart comparing an index rebalanced with a traditional process versus an index rebalanced according to certain example embodiments;

FIG. 5 is a chart that illustrates forward looking characteristics of a traditionally rebalanced index and an index rebalanced according to certain example embodiments;

FIG. 6 is a chart showing the average credit rating of a traditionally rebalanced index and an index rebalanced according to certain example embodiments;

FIG. 7 shows how a component in an index is adjusted when the index is rebalanced using traditional techniques and how an index is rebalanced according to certain example embodiments; and

FIG. 8 is a block diagram of an example computer system that is programmed according to certain example embodiments.

### DETAILED DESCRIPTION

In the following description, for purposes of explanation and non-limitation, specific details are set forth, such as particular nodes, functional entities, techniques, protocols, processes, programs, and the like in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function or process blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). As will be appreciated, the combination of a computing system (e.g., a general purpose computer), with specifically programmed or configured software results in a new machine that is functionally and structurally different from a computing system that contains no software or different software. The software program instructions and data may be stored on non-transitory computer-readable storage medium and when the instructions are executed by a computer or other suitable processor control, the computer or processor performs the functions.

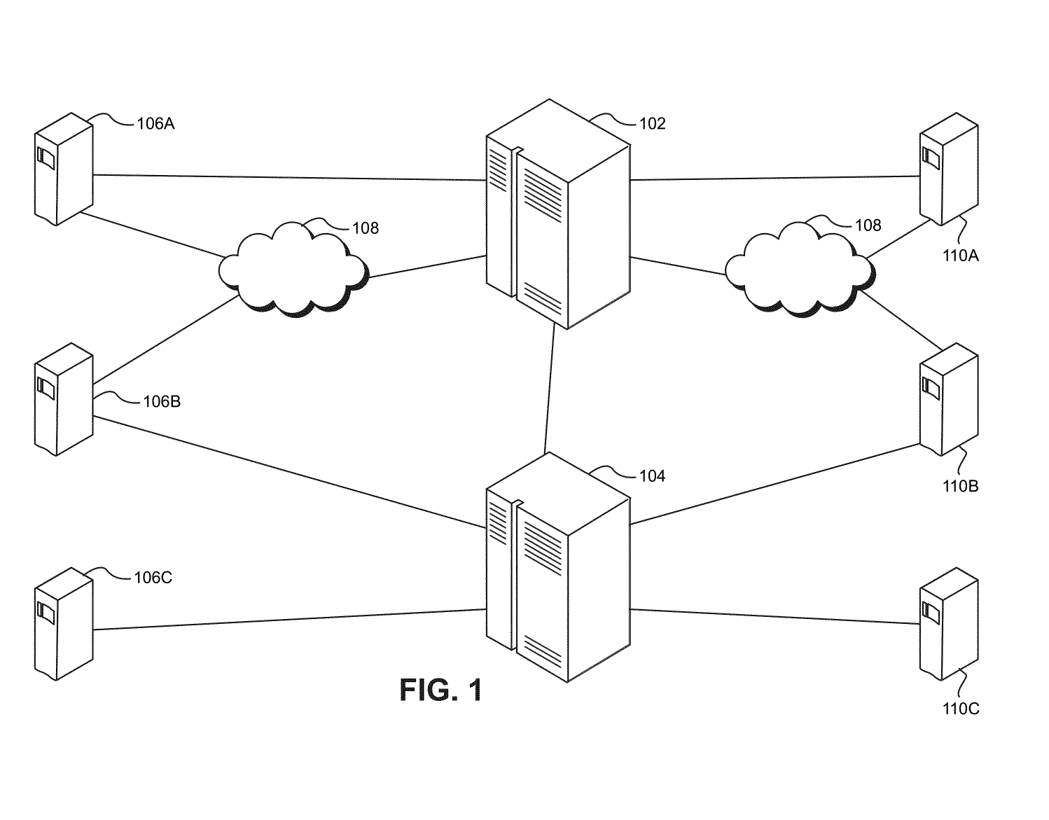

By way of introduction, FIG. 1 shows a non-limiting example function block diagram of a computer-implemented index system coupled via a network to data source computer systems and subscriber or client computing systems.

Trading exchange computer system 102 includes a CPU, a memory, and a data transmission device. In certain example embodiments, these systems may include multiple processors and/or memories and may be designed for fail-safe redundancy (e.g., with multiple computing devices operating to provide functionality). The data transmission device can be, for example, a network interface device that connects trading exchange computer system 102 to network 108. Trading exchange computer system 102 may be directly connected to client systems 106A and 110A via dedicated physical connections (e.g., fiber optics) or virtual dedicated connections (e.g., a virtual private network).

Client computing system 106A, 110A, 106B, and 1108 communicate with trading exchange computer system 102. For example, client systems can create electronic data messages relating to the placement of electronic orders for purchasing or selling securities. In certain instances, client systems passively receive electronic messages transmitted by trading exchange computer system 102 related to events or changes in securities managed by trading exchange computer system 102. In certain instances, client devices may receive information from other sources (not shown) that indicate, for example, a new bond has been issued. Client systems (e.g., client system 106B) may track such information and provide such data to other sources (as described below).

Index computer system 104 is a computer system configured (e.g., through appropriately designed and executing computer program structure) to manage an index of a group of securities that makeup the index. Index computer system 104 includes a processing system (e.g., at least one microprocessor), a memory device (e.g., RAM, cache memory, non-volatile storage, etc), transceiver circuitry for communicating with other computing resources. Index computer system 104 is coupled via a communication link to various data providers that provide information to index computer system 104 on components of the index (e.g., the securities). Data providers for the index computer system 104 can include trading exchange computer system 102 and client computing systems 106B and 106C. In certain examples, index computer system 104 and trading exchange computer system 102 are located within the same data center and communicate via high speed communication links. Index computer system 104 may receive a real-time data feed from trading exchange computer system 102 and use such information to calculate the value of an index based on how the underlying securities in that index have performed. In certain examples, data providers are third party services that track and maintain various pieces of information on how securities perform. In certain instances, data providers may specialize or provide such information based on asset class, sector, or category. Thus, index computer system 104 may communicate with one or more (e.g., multiple) data providers when calculating the value of an index and how the index should be balanced. As an example, an index may be a combined index that includes bonds, stocks, currency hedges, and the like. Index computer system 104 acquires information on the various components of the index from different data providers—e.g., currency information from client computer system 106C, bond information from client computer system 106B, and stock information from trading exchange computer system 102.

Index computer system 104 may store information on securities of a managed index in local storage (e.g., a listing of those securities that makeup the index) and then calculate a resulting index value from those securities (e.g., the value for the NASDAQ-100 Index). This index value may be based on the combined value (or some other metric associated with the securities) of the securities that make up the index (e.g., a weighted average). The value may be transmitted to client systems—for example, client computing system 1108 or otherwise distributed to external computing devices (e.g., a mobile device of an investor who is interested in the market represented by the calculated index).

In certain examples, computer index system 104 transmits index level, performance, constituent or analytic data related to the makeup of a particular index (or group of indexes) to client devices. For example, while client computing system 1108 may receive only the value of the index, client computing system 110C may receive data on how the components in the index have been weighted, other component information, corporate actions related to the components (e.g., news items), intraday net asset values, settlement values, currency spot values for select instruments, start-of-day and end-of-day summary data by asset class. This information may be provided daily (for example at the end of a trading day), weekly, monthly, bi-yearly, on demand (e.g., at the request of a user or a client computing system), or other programmed frequency (which may be time or event based). This information can facilitate capital performance transparency for investors, asset managers, and global financial institutions. It also may help funds that track indexes to better match the performance indicated by the calculated index value.

The securities that makeup an index can be based on any type of security or financial instrument. For example, and index may include securities such stocks, bonds, sukuks, bank loans, preferred securities, commodities, futures or options contracts, local or foreign currencies and currency hedges, or any combination thereof. As explained herein, certain example rebalancing techniques may track traditional rebalancing techniques in terms of valuation for the index over time. An example constituent bond may be, for example, within about 5 basis points (0.05%) of the weight of the bond in a “perfect” index or an index that uses a traditional method. Accordingly, the return for a fund based on an index can be considered to be identical (or nearly so) with that of the traditional technique. Generally speaking cash generating assets (e.g., bonds, dividend bearing stocks, etc) or index portfolios that have higher turnover in constituents will obtain more benefit from the techniques herein than fixed indexes of perpetual, non-cash flow generating assets.

While index valuation may not be materially different between different rebalanced indexes, the turnover experienced by those indexes may be materially different. In other words, for a index rebalanced according to the techniques herein the value of the index may track a traditionally balanced index while the amount of turnover materially diverges (perhaps significantly so)—with the technique described herein having less turnover. Such characteristics (e.g., decreased turnover) offer a way for indexes and funds that track such indexes to differentiate themselves in the market.

As used herein, buying for an index refers to adding a specific amount of a security to the index rather than strictly buying the security. Correspondingly, a sell refers to “subtracting” a specific amount of a security from an index rather than selling that security. In other words, an index provider does not engage (typically) in financial transactions when calculating an index valuation (or the rebalancing process). Instead, buy and sell actions are carried out by investors, such as funds tracking the index.

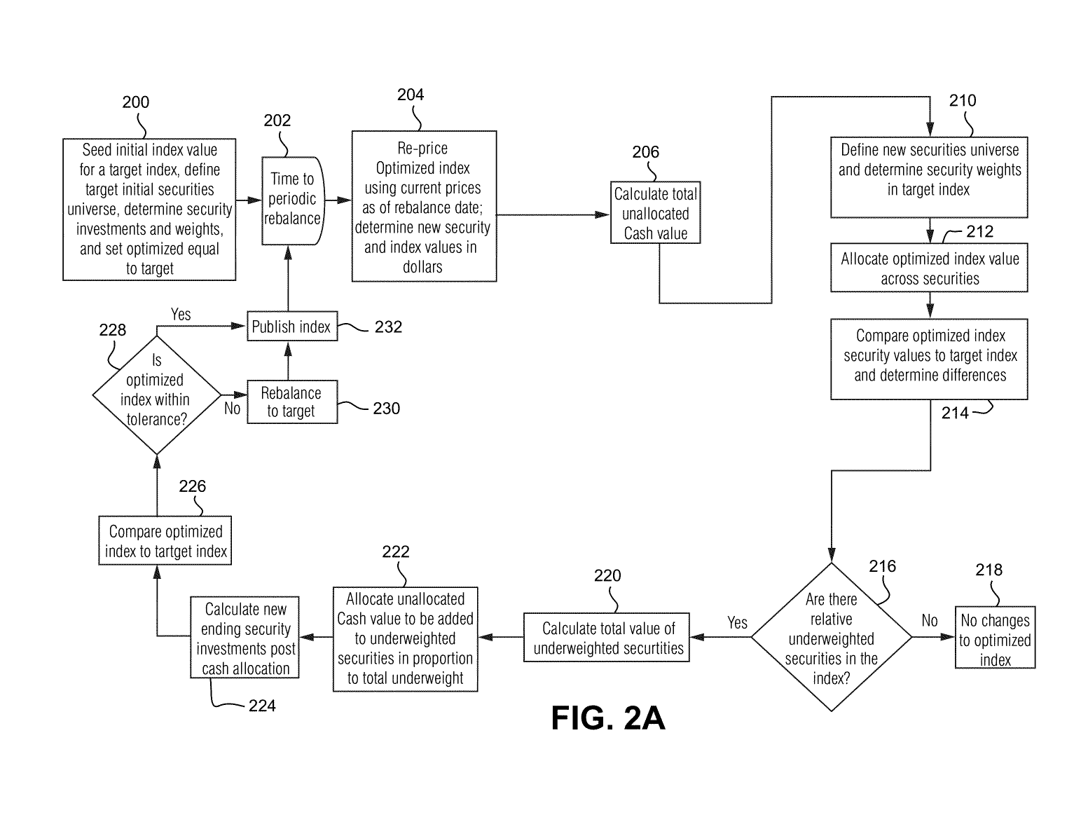

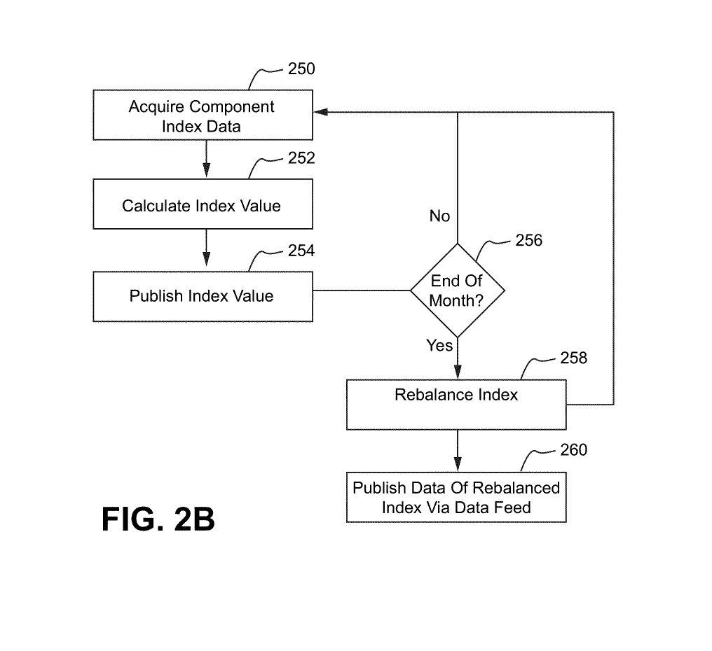

FIG. 2A is a flow chart of an example computerized rebalancing process according to certain example embodiments.

Step 200 is an initialization step used to create an index where the initial value of the index (e.g., the sum of the initial positions taken in the portfolio components) is defined. For example, an initial value may be 1 billion dollars U.S. This value may be set as (INV_{TOT t})—the total value of the index at time t. The initial securities included in the index may also be defined.

Selecting or defining the initial group of securities to be included in the index can be accomplished by applying a criteria (e.g., all stocks with a market capitalization of greater than 10 billion, the 50 largest market capitalization stocks, a securities in a particular sector or asset class, geographic area, etc), a strict selection of specific securities (e.g., a user selecting which securities to include in the index), or some combination thereof. For the initial group of securities, the process determines security investments and weights of the securities within the group and sets the optimized distribution of the securities within the group to the target distribution of the securities. As used herein, the optimized index is the index rebalanced according in the rebalancing techniques herein and the target index or distribution is the target makeup for an index.

For example, a laddered bond index may be partitioned into 5 different maturity buckets that include bonds maturing at different times in the different buckets—e.g., 20% may be devoted to 5 year bonds, another 20% to 10-year bonds, etc. The target distribution in this scenario is exactly 20% in each of the particular categories, leading to significant rebalancing to maintain 20% exposure. In contrast, the optimized distribution may float by a couple percentage points (up or down) for the respective buckets (e.g., depending on how well the assets in a particular class are doing compared to others). This “floating” aspect is a result of how certain example techniques are applied to an index over the life of the index.

The amount or value of a particular security included in the index may be defined as (INV_{S t}) and the weight of the security within the index may be defined as (INV_{SW t}).

The following is one example that is used to determine eligible bonds for a laddered index:

Issuers: Only U.S. dollar-denominated bonds issued by companies domiciled in the U.S., Canada, Western Europe, or Japan are included.

Types of Bonds: Bonds pay fixed amounts of taxable interest. The following bond types may be included: 1) fixed coupon bonds; 2) callable bonds; 3) step-ups, event-driven, rating-driven and registration-driven bonds; and 4) amortizing bonds and sinking funds with fixed sinking schedules.

Selection criteria: bonds must have: 1) a minimum credit rating of BBB—from Fitch Investor Services (“Fitch”) or Standard and Poor's Rating Group (“S&P) or Baa3 by Moody's Investors Service, Inc. (”Moody's); and 2) an outstanding face value of at least $500 million.

Exclusions: the following bond types may be excluded: 1) bonds with an initial term of less than one year; 2) Reg S bonds, 144A bonds, Eurodollar bonds and EuroMTN bonds; 3) Retail bonds; 4) Floating rate bonds; 5) Zero coupon bonds; 6) Convertible bonds; 7) Bonds cum or ex-warrant; 8) Bonds with one cash flow only; 9) New bonds that have already been called; 10) Bonds that permit issuers to make coupon payments either in cash or in new debt securities (i.e., PIK-toggle bonds); 11) Inflation or other index-linked bonds; 12) Bonds guaranteed by an agency, national or supranational government (including FDIC or TLGP); 13) Perpetual securities (including Trust Preferred); and 14) Securities for which the Index Provider is unable to, or is prohibited from providing an evaluated price.

Once the initial index is created, then in step 202, some amount of time is allowed to pass before the rebalancing process for the index is triggered. The time between rebalancing processes is determined by application need and may be daily, weekly, monthly, yearly, etc. or event based (e.g., the manager of the index manually triggers the rebalancing process, or some event was detected that triggered the rebalancing process).

Once the rebalancing is triggered, in step 204 the optimized index is re-priced using current prices as of the rebalance date. Specifically, the value of each security within the index is recalculated (INV_{S t+1}) and the total value of the index is also recalculated (INV_{TOT t+1}). For example, if a stock in the index has increased in value since the last rebalancing from 100 to 110, the value of the stock is similarly increased.

In step 206, the process calculates unallocated “cash” (INV_{CASH t+1}) in the optimized index due to corporate actions, distributions, index removals or the like. For example, bonds typically yield some recurring cash (e.g., a coupon payment). In other situations, a bond matures and the money initially spent buying the bond (or a portion thereof) is returned. For equities, a stock may have dividends. These types of distributions or actions may be tracked by an index provider (e.g., the entity running computer index system 104) and stored in memory on that system (along with other data related to the makeup of the index).

The following are examples of cash may be generated by index components for bonds: 1) coupon payments; 2) called bonds; 3) matured bonds; 4) index deletions. In certain examples, securities that are fully or partially redeemed during the month (for example, called bonds or amortizing bonds with fixed schedules) will see their market value adjusted as of the effective date of the redemption and the redemption amount treated as cash until the next rebalance.

In certain examples, unallocated cash positions (or values that represent the generated cash which are stored in the index computer system) for each security may be summed to obtain the total unallocated cash value. In certain examples, the computer index system may update the total value at the same time new information is received for respective securities—e.g., as a running total. In other words, data providers transmit messages to the index computing system with information on how much cash a given security has generated over a given time period. This information may be saved to the computing system (e.g., a database or the like) as the information is received and then referenced in step 206.

In certain examples, if there is no unallocated cash generated by the components of the index, then the process may end and return to step 202. In certain examples, the process continues through other steps shown in FIG. 2A. In other words, even when there is no unallocated cash, the process may still determine a difference between optimized and target indexes and take action based on that determination (e.g., to fully rebalance or employ some other rebalancing technique that does not rely upon generated cash values).

In step 210, the group of securities that makeup the index is re-determined and the weights (INV_{SW t+1}) of those securities in the index are re-calculated. For example, returning to the bond index example, in the time between the initial creation of the index and step 210, 2 additional bonds may have become eligible for the index (e.g., because they were just issued). Accordingly, the index must now include those bonds in its calculation. However, as two bonds are being added to the index, the weights of other bonds already in the index may need to be decreased.

In step 212, the weight calculation is used to determine the new target holding for each security in the index. The calculation involved in this process is expressed as: INV_{S t+1 target}=INV_{TOT t+1}*INV_{SW t+1 target}. In other words, the target value for a particular security in the index is the product of the total value of the index and the weight of that security within the index (e.g., a percentage).

In step 214, for each security, the calculated target value (from step 212) is compared to the calculated value of the security from step 204. This may be expressed as W_{S t+1}=INV_{S t+1}−INV_{S t+1 target}.

In step 216, the process determines if there are any underweighted securities in the index. In other words, are there any securities for which INV_{S t+1} is less than INV_{S t+1 target}. If there are no underweighted securities, then the process proceeds to step 218, no changes are performed on the index, and the process resets to step 202.

In certain example embodiments, the process may determine if the underweighted securities are within a certain margin of the target value. If they are within that margin, then the process may exit and take no function action. For example, if the target value of a security is 3 and the calculated value of the security is 2.99, then the process may determine that no further changes are needed and simply exit at step 218.

In step 220, if there are underweighted securities, then the underweighted total of those securities is calculated. This may be expressed as: UW_{TOT t+1}=SumIF (INV_{S t+1}−INV_{S t+1 target}, “<0”). In other words, sum the differences between the total value of each security and its target value if that difference is less than 0. This can then capture the total underweighted value for the securities that are underweighted with respect to their target value. As can be seen from this process, securities that are overweighted by the index are not adjusted in value.

In step 222, the unallocated cash value maintained by the index computing system is used to add value to the underweighted securities. This addition in done in proportion to the total underweight value calculated in step 220. This may be expressed as INV_{S(add)t+1}=(UW_{S t+1}/UW_{TOT t+1})*INV_{CASH t+1}. Thus, for a given underweighted security in the index, the value of that security within the index will be increased by an amount based on the total unallocated cash and that securities portion of the underweighted total.

In certain examples, other techniques for applying the unallocated cash value may be used. For example, factors such as credit rating or type of security may be used to determine how the unallocated funds are to be allocated. In certain examples, securities may be adjusted to hit their target amount based on such factors. Securities may be “ranked” and the highest ranked security may be brought up to its target value within the index before other lower ranked securities are adjusted in value. In certain examples, the distribution could be randomized. In certain examples, one or more of the above process may be combined to form hybrid-like distribution model.

In step 224, the new value of securities after their adjustment in step 222 are calculated to obtain the interim values and weights of the index constituents. The weights of the securities within the index may also be calculated. The interim value of the securities is expressed as: INV_{S t+1end}=INV_{S t+1}+INV_{S(add)t+1}. The interim weighting of the securities may be expressed by: INV_{S t+1end}/INV_{TOT t+1}.

In step 226, the index is re-compared to the target index (from step 212). In certain examples, the comparison can be sector based, maturity based (e.g., etc maturity bucket), security based (e.g., the weightings of each security are compared), or based across the whole index.

Based on the comparison in step 226, in step 228, the process determines if the optimized index is within a tolerance threshold of the target index—e.g., to ensure the index is going to deliver the risk/reward characteristics that are similar to that of the target weight index. As noted above, this determination may be based on various different factors. For example, in the bond index example, the process may determine if each year of maturity is within its tolerance level (a level that may be the same or different for the respective maturity levels). In other examples, the determination may be on a security by security basis, on the basis of security sector, etc.

In any event, if the optimized index (or portions thereof) is not within a tolerance threshold, then in step 230, the process may fully rebalance the index (e.g., using the traditional technique or some other optimization technique) to acceptable weights and the rebalanced index becomes the live index that is published in step 232. Another rebalancing technique that may be employed in certain instances is described in U.S. Pat. No. 6,061,663, the entire contents of which are hereby incorporated by reference.

If the index is with a tolerance threshold, then it may be set to be the “live” index and published in step 232.

In certain examples, all of the above steps from FIG. 2A are computerized processes (or parts thereof) that are executed by an index provider computer system. However, it will be understood that, one or more of the steps may be offloaded to a third party (e.g., an external computing system) or the like.

FIG. 2B is a flow chart showing a computerized process for maintaining, publishing, and/or updating an index according to certain example embodiments.

In step 250, component data for an index is acquired or received. As discussed above, such information may be obtained or received from a variety of different sources (data providers, exchanges, etc).

In step 252, based on the acquired data, the value of index components may be calculated. This may be similar to step 204 in FIG. 2A.

In step 254, the calculated index value is published. For example, a bond index may be updated during the trading day (or the end of the trading day) as the underlying bonds in the index move in value. The updated value may give clients a way to quickly grasp whether the bond market is moving up or down (e.g., as the index value represents a broad understanding of its underlying components).

In step 256, the process determines if it is the end of the month. Or more specifically the computerized process determines if it is the end of a month and the end of the trading day. If this condition is not satisfied, then the process loops back to step 250.

However, if it is the end of the month (and this particular index has been setup to be rebalanced monthly), then an example rebalanced process may be implemented for the index in step 258. The process described in FIG. 2A may be one such process that may run monthly to rebalance an index. As noted herein, rebalancing an index may be triggered at periods other than on a monthly basis (e.g., weekly or daily).

In step 260, once the subject index has been rebalanced, then the updated component information is published via a data feed to selected subscribers (e.g., client device 110C).

In certain examples, the value of each index equals the aggregate value of its index par value multiplied by each component security's evaluated midpoint price plus accrued interest divided by the index divisor. The index divisor serves the purpose of scaling the aggregate value to a lower order of magnitude for reporting purposes. In certain examples, the formula for index valuation is as follows: Aggregate Index Market Value/Divisor. In certain examples, this information is calculated once per trading day and then published (e.g., after the close of the U.S. bond market).

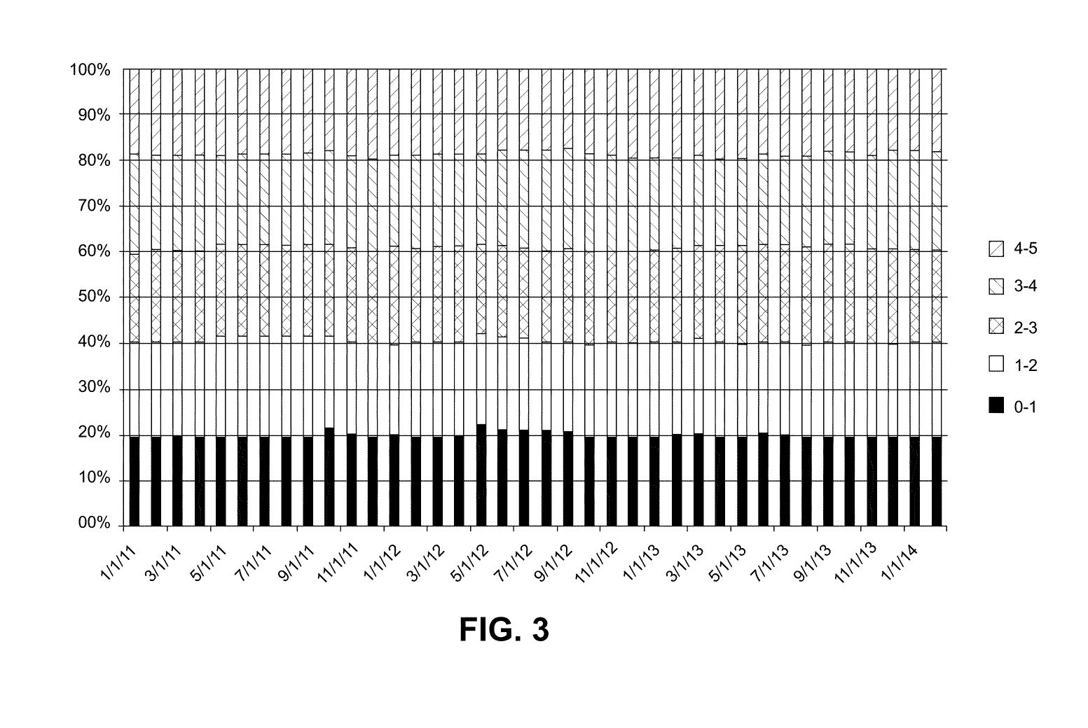

The following discussion (including FIGS. 3-7) relates to example data generated by running a one-billion dollar laddered bond index rebalanced according to traditional techniques (index A—sometimes referred to as “traditional”) and a one-billion dollar laddered bond index rebalanced according to certain example embodiments described herein (index B—sometimes referred to as the “TOP” index). The laddered bond indexes were split into 5 different “buckets” that included 0-1 year maturity bonds, 1-2 year maturity bonds, 2-3 year maturity bonds, 3-4 year maturity bonds, and 4-5 year maturity bonds. Each bucket of the index was targeted to be 20% of the overall index valuation. Index A will perfectly (or nearly so) maintain the targeted 20% over the lifetime of the index.

Tables 1 and 2 show example results for index A and index B.

TABLE 1
Example Bond Portfolio Between
Dec. 31, 2010 And Feb. 28, 2014

| | Average Annualized Return | Average Annualized Risk |
|---|---|---|
| Index A | 3.02% | 1.73% |
| Index B | 3.03% | 1.77% |

Here, the average annualized rate of return using the traditional rebalancing process was nearly identical (slightly lower even) than the rebalancing process according to certain example embodiments. Similarly, there was only a 0.04% annualized risk difference for this example portfolio between the two rebalancing techniques. Thus, the performance of funds based on these respective indexes (one that employed a traditional rebalancing process and the other that employed a rebalancing process according to example embodiments described herein) may be very close to one another.

Table 2 shows the anticipated index turnover of the respective rebalancing techniques.

TABLE 2
Example Bond Portfolio Between
Dec. 31, 2010 And Feb. 28, 2014

| | Average | Average | Average | |
|---|---|---|---|---|
| | Monthly | Monthly | Monthly | Average |
| | Index | Index Add | Index Reduction | Gross |
| | Cash | (Buy) | (Sell) | (Net) Trade |
| A | 2.4% | 11.5% | (9.1%) | 20.6% (2.4%) |
| B | 2.4% | 2.4% | 0 | 2.4% (2.4%) |

The average amount of index cash generated by component members on a monthly basis is the same (2.4%) between index A and index B. However, the average index add/reduction (buy and sell) requirements are very different between the indexes. Specifically, on average, index A added to securities (bought) 11.5% of its valuation on a monthly basis while reducing from securities (selling) 9.1% of its total valuation. It should be noted that the sell percentage shown in table 2 is with respect to sells that are, primarily, related to reducing the weight of constitutes within the security (e.g., to make room for a new security). These types of sells generally do not add “value” to an index (or a fund tracking the index). The reduction (sell) data shown above does not include sales of securities being removed from the index (e.g., the security no longer qualifies) or the like. The average “gross” trade is the sum of the absolute adds and deletes in a particular month, and may represent a trading that could occur in a portfolio tracking the index. The average “net” trade is the difference between the buy and sell averages and, theoretically, is the amount that is “spent” in order to balance the index. However, as explained below, there are other factors that drive up the cost the rebalancing process for index A.

For index B, the average buy is 2.4%. This is expected because, as shown in FIG. 2A, the process is constrained by the amount of unallocated “cash” (which is represented as a value by the index provider). Accordingly, the 2.4% for index B is significantly less than the 11.5% of index A. Also, there are no reductions (sells) triggered for index B as the example rebalancing process does not decrease a security's weight simply as a result of other index adds (e.g., to proportionately reduce the value of a security in the index). As with index A, net trading percentage for index B is 2.4%. However, the gross index turn turnover is higher for index A than index B (and thus may be higher for funds tracking the index).

The following example illustrates this problem. When an index based on 100 equally weighted securities (e.g., each weighted % 1) is required to rebalance to add an additional 2 securities, the value of those 2 securities is included in the index and every security will therefore have an index weight of 0.98%. For the traditional rebalancing process, the value of the original 100 securities is reduced from 1% to 0.98%. Accordingly, funds tracking the index must buy the 2 additional securities at 0.98% weight (this action would theoretically “add” value to the fund) and sell minute amounts (0.98%-1.0%=0.02%) of the original 100 securities (which would typically not add value). These types of small incremental adjustments can be expensive to replicate in funds tracking indexes, particularly in markets demarked by (relatively) high trading costs (commissions, stamp fees, bid-offer spread, etc).

In the above situation, the turnover generated by index A can result in a fund tracking the index trading 20.6% of its portfolio on a monthly basis in order to maintain perfect weights vis a vis the index. In the bond market, bid offer spread (the fee paid to bond dealers in compensation for maintaining an inventory/market) on investment grade bonds can be as high as 1%. In this example, funds seeking to exactly deliver the performance of an index with 20.6% turnover monthly would expect to experience a relative underperformance of 0.206% per month (20.6%×1% bid-offer spread) due to the costs of their trading securities. Furthermore, trading small amounts of some securities can increase the bid/offer spread required by trading partners to entice them to purchase small numbers of securities.

Using a traditional rebalancing process, the bid/offer spread “problem” is multiplied many times over as a fund tracking index A seeks to match the continually updated makeup of the base index. In contrast, a fund tracking index B will make less trades and have less “exposure” to the bid/offer spread issue described above.

FIG. 3 shows allocation data for each maturity bucket in the laddered index over the course of a 3 year period for index B. As can be seen, over this three year period, each of the maturity buckets in the index becomes slightly mis-weighted with some buckets being overweighted and some being underweighted. However, in most instances, these mis-weights within the index are non-material. In other words, the risk associated with the index is not changed in material manner based on these slight mis-weights.

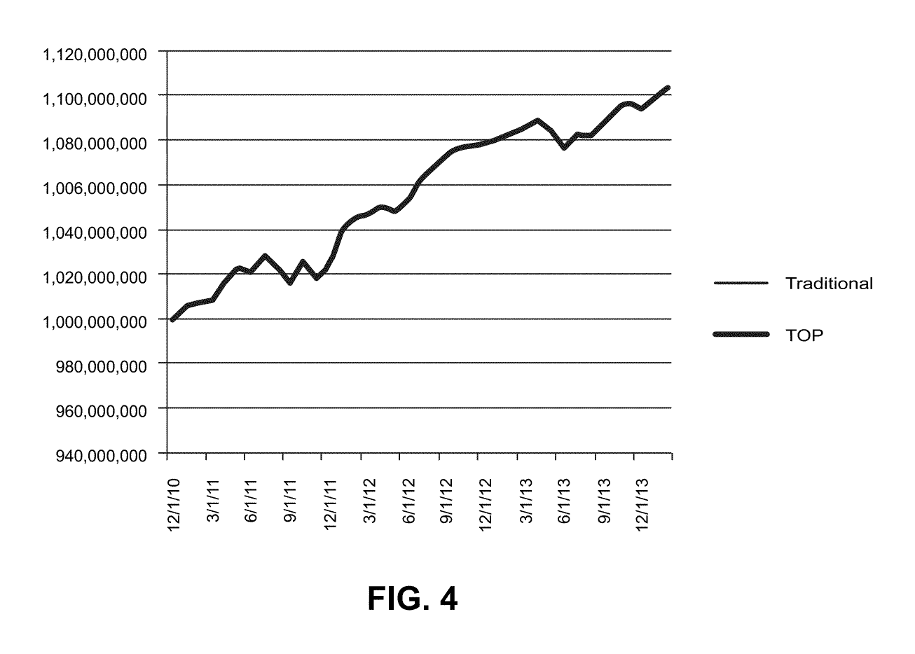

FIG. 4 is a chart comparing the performance of index A to index B. Here, the valuation of index A and index B are indistinguishable from each other as the two lines on the chart are blended together.

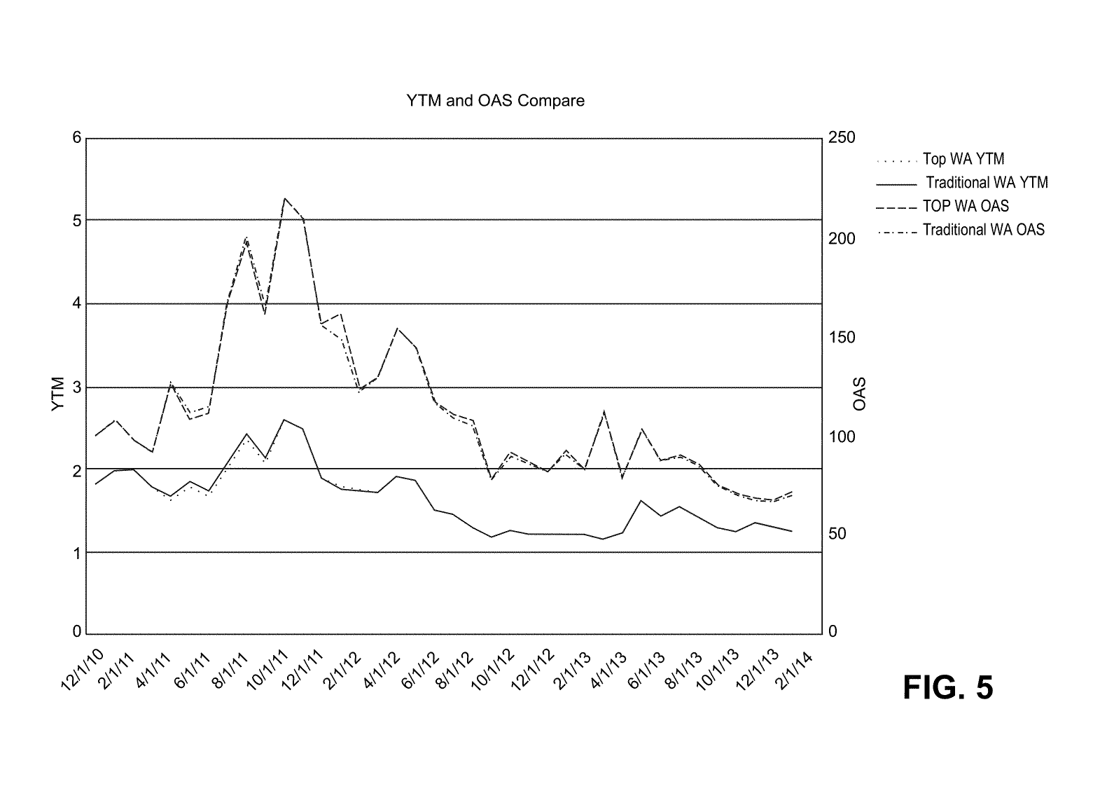

FIG. 5 is a chart that illustrates forward looking characteristics of index A and index B and shows both yield-to-maturity (YTM) and the option-adjusted-spread (OAS) or spread (e.g., to U.S. treasuries) for the two indexes. In this chart, while there is some deviation between index A and index B over the 3 year period for the YTM, those deviations are corrected after a month or two and index B ends up tracking index A. The spread for index A and index B is also fairly close (and at times indistinguishable).

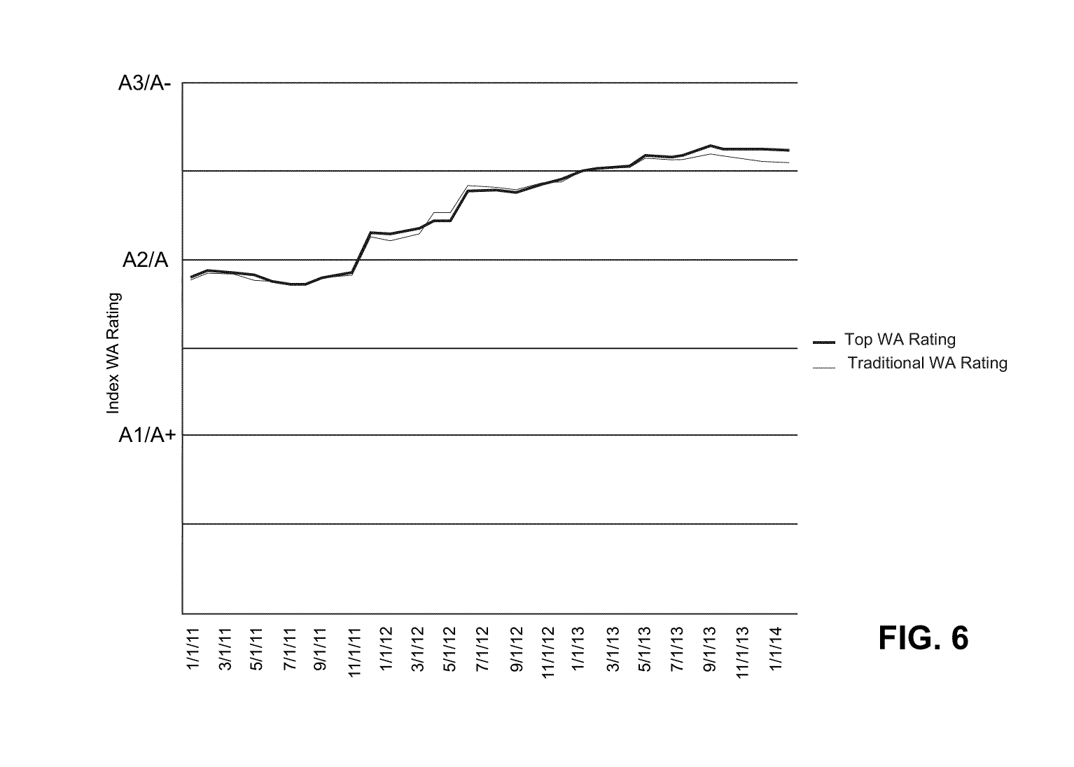

FIG. 6 is a chart showing the average credit rating of index A and index B where the credit rating of all of the bonds in the index is averaged by weight. While the credit rating of both indexes drops over the three-year period, their respective credit ratings are similar. This indicates that the reason for the drop is due to the index makeup (e.g., some bonds dropping in credit rating) rather than the implemented rebalancing process.

FIGS. 3-6 thus illustrate how the risk characteristics of the two indexes track each other over the indicated period.

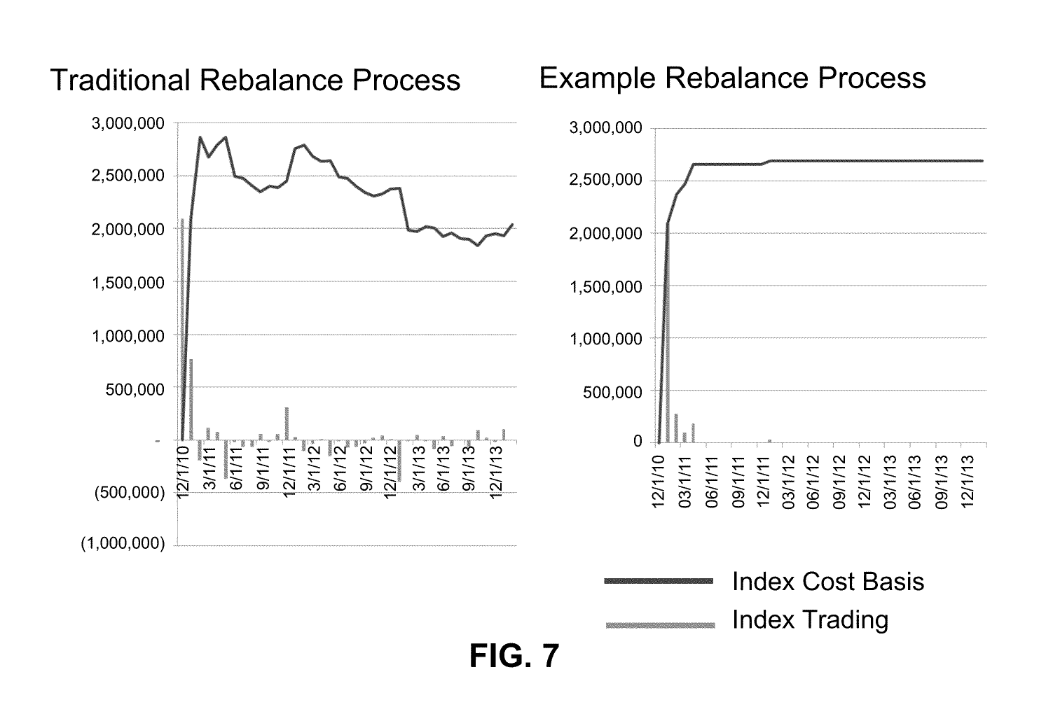

FIG. 7 shows how par value of an individual component bond in indexes A and B fared over the three-year period. Using the traditional rebalancing process (the left chart), there is a large initial add to the par value of the bond to the index. Subsequently, as other bonds are added to the index, the value of the individual component bond within the index is decreased (e.g., to maintain its target weight within the index). The smaller bar graph shows trading (adds and subtractions for the index) that took place for this bond during the indicated three-year period.

Trades that occur in a fund tracking the index can be motivated by “good” (adding diversification to the fund) and “bad” (small but constant reshuffling) index activity. Typically, good index activity can be used to justify the corresponding trading activity through a provided benefit. However, bad index activity, as discussed above, can reduce total performance of the fund and lower its relative performance vis a vis the index (which pays no transaction costs) due to, for example, the bid offer spread present in the market for the particular security type (e.g., bonds—especially for lower denominations of bonds) for no material benefit.

In contrast to the traditional rebalancing technique, the right chart of FIG. 7 shows that the par amount of the bond represented in the index remains relatively stable over the 3-year period. Fund managers seeking to track index B would incur trading costs for their bond purchases motivated by good index activity, but would not be required to trade (and thus incur costs) the portfolio for bad index activity to the extent required by tracking index A. This reduction in trading activity can have a material impact on the fund's ability to track the index as well as the total performance.

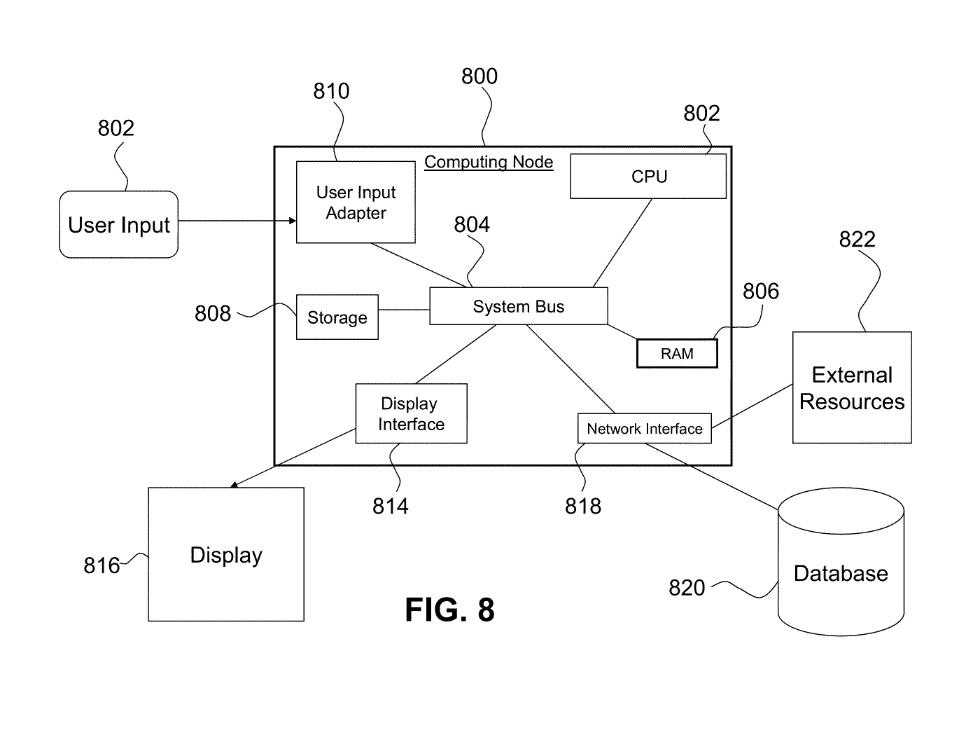

FIG. 8 is a block diagram of an example computer system, or computing node, that is programmed according to certain example embodiments. The computer system may be index computer system 104, trading exchange computer system 102, client computing systems, etc. Computing system 800 includes a central processing unit or CPU 802, a system bus 804 that communicates with RAM 806, and storage 808. The storage 808 can be magnetic, flash based (e.g., for a mobile client device), solid state, or other storage technology. The system bus 804 communicates with user input adapter 810 (e.g., PS/2, USB interface, or the like) that allows users in input commands to computing node 800 via a user input device 812 (e.g., a keyboard, mouse, touch panel, or the like). The results of the processing may be displayed to a user on a display 816 (e.g., an LCD) via display interface 414 (e.g., a video card or the like).

Computing system 800 may also include a network interface 818 (e.g., a transceiver) to facilitate wired (e.g., Ethernet—802.3x) and/or wireless communication (WiFi/802.11x protocols, cellular technology, and the like) with external systems 822 and/or databases 820. External systems 822 may include other processing systems, systems that provide third party services, client devices, server systems, or other computing nodes similar to that of computing node 800 (e.g., to form a distributed computing system).

External systems 822 may also include network attached storage (NAS) to hold large amounts of data. External systems, along with the internal storage and memory, may form a storage system for storing and maintaining information (e.g., graphical models, event log data, etc). Such a system may communicate with users and/or other computing systems to implement the techniques described herein. The database 820 may include relational, object orientated, or other types of databases for storing information (e.g., the makeup of an index, a tracked about of cash that has been generated by index components, etc).

In certain examples, a CPU may include multiple cores (e.g., (core1, core2, core3, and core4) that are all coupled to on-die memory (e.g., L2 or L3 cache memory). It will be appreciated that other architecture types may be used. For example, a multiple processor system may be used and the distinct processors may share fast onboard cache memory. Systems with additional, fewer, or single cores are also contemplated.

Although process steps, algorithms or the like described herein may be described in a particular order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of non-transitory, computer-readable media may be involved in carrying data (e.g., sequences of instructions) to a processor. For example, data may be (i) delivered from RAM to a processor; (ii) or instructions for a process may be stored in an instruction register and loaded by a processor. Instructions and/or data may be carried over other types of transmission medium (e.g., wire, wireless, optical, etc.) and/or transmitted according to numerous formats, standards or protocols, such as Ethernet (or IEEE 802.3), SAP, ATP, Bluetooth, and TCP/IP, TDMA, CDMA, 3G, etc.; Such transitory signals may be coupled to non-transitory media (e.g., RAM, a receiver, etc), thus transitory signals will be coupled to non-transitory media. The transitory and non-transitory signals, instructions, and/or data, may be encrypted to ensure privacy or prevent fraud in any of a variety of ways well known in the art.

Although various embodiments have been shown and described in detail, the claims are not limited to any particular embodiment or example. None of the above description should be read as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

1. A index rebalancing computer system for a group of securities represented by an index, the index rebalancing computer system comprising:
a transceiver configured to send and receive electronic communication signals from or to one or more remote computers;
a memory device configured to store:
a listing of a group of securities used to generate the index; and
an indication of an amount of cash generated by at least a first security from among the group of securities over a certain time period; and
a processing system that includes at least one processing circuit coupled to the memory and the transceiver, the processing system configured:
in response to an index rebalance request signal, rebalance the index towards a target index by at least adjusting a weight of a second security associated with in the group of securities as a function of the stored indication of the amount of cash generated by at least the first security over the certain time period;
calculate an index value for the index based on the group of securities that includes the second security with the adjusted weight; and
transmit index component data, via the transceiver, to the one or more remote computers in accordance with the rebalanced index.

2. The index rebalancing computer system of claim 1, whereby turnover of the index is decreased such that a value of a security in the index is not adjusted when index addition security weight reductions or index deletion security weight increases are performed for other index components.

3. The index rebalancing computer system of claim 1, wherein the processing system is further configured to:
calculate, for each security in the group of securities, a target weighting of the respective security within the group;
calculate, for each security in the group of securities, an actual weighting of the respective security within the group;
calculate a total underweight value as a sum of each security that has an actual weighting that is less than the corresponding target weighting, where the second security has an actual weight less than a target weight;
calculate a share that the difference between the actual weight and the target weight of the second security contributes to the summed total underweight value,
wherein the weight of the second security is adjusted in proportion to the calculated share.

4. The index rebalancing computer system of claim 1, wherein the group of securities consists of bonds.

5. The index rebalancing computer system of claim 4, wherein the group of securities is a laddered group of bonds.

6. The index rebalancing computer system of claim 1, wherein the group of securities comprises multiple different asset classes.

7. The index rebalancing computer system of claim 1, wherein the index rebalance request signal is automatically triggered on a monthly basis and the certain period is a month.

8. The index rebalancing computer system of claim 1, wherein the memory device is further configured to store an indexing criterion used to determine additions and deletions of securities from the index,
wherein the processing system is further configured to:
add a third security to the group of securities; and
set a weight of the third security based on the amount of cash generated by at least a first security.

9. The index rebalancing computer system of claim 8, wherein the rebalancing process does not decrease values of existing securities in the group of securities as a result of the third security being added to the group of securities.

10. A non-transitory computer readable storage medium storing computer readable instructions for use with an index rebalancing computer system that rebalances a group of securities represented by an index, the index rebalancing computer system including at least one processor, a transceiver, an a memory device, the computer readable instructions comprising instructions that cause the at least one processor to:
store, to the memory device, a listing of a group of securities used to generate the index;
store, to the memory device, a value that represents an amount of cash generated by at least a first security from among the group of securities since a prior rebalance request;
in response to an index rebalance request instruction, rebalance the index by at least adjusting a weight of a second security included in the group of securities as a function of the stored value that represents an amount of cash generated by at least the first security;
calculate an index value for the index based on the group of securities that includes the second security with the adjusted weight; and
communicate, using the transceiver, index component data to the one or more remote computing systems in accordance with the rebalancing of the index.

11. The non-transitory computer readable storage medium of claim 10, wherein the instructions are further configured to cause the at least one processor to:
calculate, for each security in the group of securities, a target weighting of the respective security within the group;
calculate, for each security in the group of securities, an actual weighting of the respective security within the group;
calculate a total underweight value as a sum of each security that has an actual weighting that is less than the corresponding target weighting, where the second security has an actual weight less than a target weight;
calculate a share that the actual weight and the target weight of the second security contributes to the summed total underweight value,
wherein the weight of the second security is adjusted in proportion to the calculated share.

12. The non-transitory computer readable storage medium of claim 11, wherein the actual weighting and the target weighting are, respectively, actual and target values for the corresponding security.

13. The non-transitory computer readable storage medium of claim 10, wherein the group of securities comprises multiple different asset classes.

14. The non-transitory computer readable storage medium of claim 10, wherein the index rebalance request is automatically triggered on a monthly basis.

15. The non-transitory computer readable storage medium of claim 10, wherein the memory device stores an indexing criteria used to determine additions and deletions of securities from the index,
wherein the instructions are further configured to cause the at least one processor to:
add a third security to the group of securities;
set the weight of the third security based on the amount of cash generated by at least a first security,
wherein the addition of the third security to the group of securities for a rebalancing decreases the weight each one of the existing securities has within the index, but does not decrease the respective value assigned to those securities within the index.

16. A method of rebalancing an index of a group of securities on a computer system that includes at least one processor, the method comprising:
determining a group of securities used to generate the index;
storing, to a memory device of the computer system, a value that represents an amount of cash generated by at least a first security from among the group of securities;
rebalancing, using the at least one processor, the index towards by at least adjusting a weight of a second security included in the group of securities based on the stored value that represents the amount of cash generated by at least the first security;
calculating, using the at least one processor, an index value for the index based on the group of securities that includes the second security with the adjusted weight; and
communicating, using a transceiver coupled to the at least one processor, index component data to the one or more remote computing devices in accordance with the rebalanced index.

17. The method of claim 16, further comprising:
calculating, for each security in the group of securities, a target weighting of the respective security within the group;
calculating, for each security in the group of securities, an actual weighting of the respective security within the group;
calculating a total underweight value as a sum of each security that has an actual weighting that is less than the corresponding target weighting, where the second security has an actual weight less than a target weight;
calculating a share that the actual weight and the target weight of the second security contributes to the summed total underweight value,
wherein the weight of the second security is adjusted in proportion to the calculated share.

18. The method of claim 16, wherein the group of securities consists of bonds.

19. The method of claim 18, wherein the group of securities is a laddered group of bonds.

20. The method of claim 16, further comprising:
adding a third security to the group of securities; and
setting a weight of the third security in the group of securities based on the amount of cash generated by at least a first security,
wherein the proportional weight of existing securities within the index is decreased, but the value assigned the existing securities is not decreased in response the addition of the third security.
